(19) United States
(12) Patent Application Publication
(10) Pub. No.: US 2011/0304618 A1
(43) Pub. Date: Dec. 15, 2011

(54) CALCULATING DISPARITY FOR THREE-DIMENSIONAL IMAGES

(75) Inventors: YING CHEN, San Diego, CA (US); MARTA KARCZEWICZ, San Diego, CA (US)

(73) Assignee: QUALCOMM Incorporated, San Diego, CA (US)

(21) Appl. No.: 12/814,651

(22) Filed: Jun. 14, 2010

(51) Int. Cl. G06T 15/00

(52) U.S. Cl. 345/420

(57) ABSTRACT

An apparatus may calculate disparity values for pixels of a two-dimensional image based on depth information for the pixels and generate a second image using the disparity values. The calculation of the disparity value for a pixel may correspond to a linear relationship between the depth of the pixel and a corresponding disparity range. In one example, an apparatus for rendering three-dimensional image data includes a view synthesizing unit configured to calculate disparity values for a plurality of pixels of a first image based on depth information associated with the plurality of pixels and disparity ranges to which the depth information is mapped, wherein the disparity values describe horizontal offsets for corresponding ones of a plurality of pixels for a second image. The apparatus may receive the first image and depth information from a source device. The apparatus may produce the second image using the first image and disparity values.

### TECHNICAL FIELD

This disclosure relates to rendering of multimedia data, and in particular, rendering of three-dimensional picture and video data.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to one or more other frames or slices.

### SUMMARY

In general, this disclosure describes techniques for supporting three-dimensional video rendering. More specifically, the techniques involve receipt of a first two-dimensional image and depth information, and production of a second two-dimensional image using the first two-dimensional image and the depth image that can be used to manifest three-dimensional video data. That is, these techniques relate to real time conversion of a monoscopic two-dimensional image to a three-dimensional image, based on estimated depth map images. Objects may generally appear in front of the screen, at the screen, or behind the screen. To create this effect, pixels representative of objects may be assigned a disparity value. The techniques of this disclosure include mapping depth values to disparity values using relatively simple calculations.

In one example, a method for generating three-dimensional image data includes calculating, with a three-dimensional (3D) rendering device, disparity values for a plurality of pixels of a first image based on depth information associated with the plurality of pixels and disparity range to which the depth information is mapped, wherein the disparity values describe horizontal offsets for corresponding pixels for a second image, and producing, with the 3D rendering device, the second image based on the first image and the disparity values.

In another example, an apparatus for generating three-dimensional image data includes a view synthesizing unit configured to calculate disparity values for a plurality of pixels of a first image based on depth information associated with the plurality of pixels and a disparity range to which the depth information is mapped, wherein the disparity values describe horizontal offsets for corresponding pixels for a second image, and to produce the second image based on the first image and the disparity values.

In another example, an apparatus for generating three-dimensional image data includes means for calculating disparity values for a plurality of pixels of a first image based on depth information associated with the plurality of pixels and a disparity range to which the depth information is mapped, wherein the disparity values describe horizontal offsets for corresponding pixels for a second image, and means for producing the second image based on the first image and the disparity values.

The techniques described in this disclosure may be implemented at least partially in hardware, possibly using aspects of software or firmware in combination with the hardware. If implemented in software or firmware, the software or firmware may be executed in one or more hardware processors, such as a microprocessor, application specific integrated circuit (ASIC), field programmable gate array (FPGA), or digital signal processor (DSP). The software that executes the techniques may be initially stored in a computer-readable medium and loaded and executed in the processor.

Accordingly, in another example, a computer-readable storage medium comprises instructions that, when executed, cause a processor of a device for generating three-dimensional image data to calculate disparity values for a plurality of pixels of a first image based on depth information associated with the plurality of pixels and disparity ranges to which the depth information is mapped, wherein the disparity values describe horizontal offsets for corresponding pixels for a second image, and produce the second image based on the first image and the disparity values.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system in which a source device sends three-dimensional image data to a destination device.

FIG. 2 is a block diagram illustrating an example arrangement of components of a view synthesizing unit.

FIGS. 3A-3C are conceptual diagrams illustrating examples of positive, zero, and negative disparity values based on depths of pixels.

FIG. 4 is a flowchart illustrating an example method for using depth information received from a source device to calculate disparity values and to produce a second view of a scene of an image based on a first view of the scene and the disparity values.

FIG. 5 is a flowchart illustrating an example method for calculating a disparity value for a pixel based on depth information for the pixel.

### DETAILED DESCRIPTION

The techniques of this disclosure are generally directed to supporting three-dimensional image, e.g., picture and video, coding and rendering. More specifically, the techniques involve receipt of a first two-dimensional image and depth information, and production of a second two-dimensional image using the first two-dimensional image and the depth image that can be used to manifest three-dimensional video data. The techniques of this disclosure involve calculation of disparity values based on depth of an object relative to a screen on which the object is to be displayed using a relatively simple calculation. The calculation can be based on a three-dimensional viewing environment, user preferences, and/or the content itself. The techniques provide, as an example, a view synthesis algorithm that does not need to be aware of the camera parameters when the two-dimensional image was captured or generated and is simply based on a disparity range and a depth map image, which does not need to be very accurate. In this disclosure, the term “coding” may refer to either or both of encoding and/or decoding.

The term disparity generally describes the offset of a pixel in one image relative to a corresponding pixel in the other image to produce a three-dimensional effect. That is, pixels representative of an object that is relatively close to the focal point of the camera (to be displayed at the depth of the screen) generally have a lower disparity than pixels representative of an object that is relatively far from the focal point of the camera, e.g., to be displayed in front of the screen or behind the screen. More specifically, the screen used to display the images can be considered to be a point of convergence, such that objects to be displayed at the depth of the screen itself have zero disparity, and objects to be displayed either in front of or behind the screen have varying disparity values, based on the distance from the screen at which to display the objects. Without loss of generality, objects in front of the screen are considered to have negative disparities whereas objects behind the screen are considered to have positive disparity.

In general, the techniques of this disclosure treat each pixel as belonging to one of three regions relative to the screen: outside (or in front of) the screen, at the screen, or inside (or behind) the screen. Therefore, in accordance with the techniques of this disclosure, a three-dimensional (3D) image display device (also referred to as a 3D rendering device) may map a depth value to a disparity value for each pixel based on one of these three regions, e.g., using a linear mathematical relationship between depth and disparity. Then, based on the region to which the pixel is mapped, the 3D renderer may execute a disparity function associated with the region (which is outside, inside or at the screen) to calculate the disparity for the pixel. Accordingly, the depth value for a pixel may be mapped to a disparity value within a range of potential disparity values from minimal (which may be negative) disparity to a maximum positive disparity value. Or equivalently, the depth value of a pixel may be mapped to a disparity value within a range from zero to the maximum positive disparity if it is inside the screen, or within a range from the minimal (negative) disparity to zero if it is outside of the screen. The range of potential disparity values from minimal disparity (which may be negative) to maximum disparity (which may be positive) may be referred to as a disparity range.

Generation of a virtual view of a scene based on an existing view of the scene is conventionally achieved by estimating object depth values before synthesizing the virtual view. Depth estimation is the process of estimating absolute or relative distances between objects and the camera plane from stereo pairs or monoscopic content. The estimated depth information, usually represented by a grey-level image, can be used to generate arbitrary angle of virtual views based on depth image based rendering (DIBR) techniques. Compared to the traditional three-dimensional television (3DTV) systems where multi-view sequences face the challenges of efficient inter-view compression, a depth map based system may reduce the usage of bandwidth by transmitting only one or a few views together with the depth map(s), which can be efficiently encoded. Another advantage of the depth map based conversion is that the depth map can be easily controlled (e.g., through scaling) by end users before it is used in view synthesis. It is capable of generating customized virtual views with different amount of perceived depth. Therefore, video conversion based on depth estimation and virtual view synthesis is then regarded as a promising framework to be exploited in 3D image, such as 3D video, applications. Note that the depth estimation can be done even more monoscopic video wherein only a one view 2D content is available.

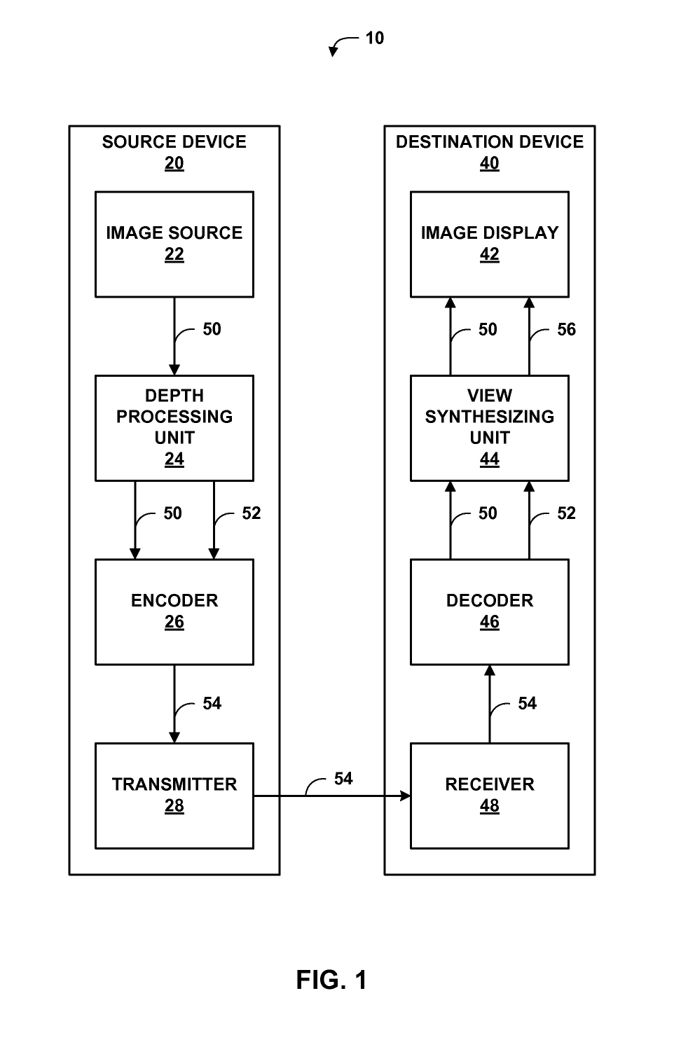

FIG. 1 is a block diagram illustrating an example system 10 in which destination device 40 receives depth information 52 along with encoded image data 54 from source device 20 for a first view 50 of an image for constructing a second view 56 for the purpose of displaying a three-dimensional version of the image. In the example of FIG. 1, source device 20 includes image sensor 22, depth processing unit 24, encoder 26, and transmitter 28, while destination device 40 includes image display 42, view synthesizing unit 44, decoder 46, and receiver 48. Source device 20 and/or destination device 40 may comprise wireless communication devices, such as wireless handsets, so-called cellular or satellite radiotelephones, or any wireless devices that can communicate picture and/or video information over a communication channel, in which case the communication channel may comprise a wireless communication channel. Destination device 40 may be referred to as a three-dimensional display device or a three-dimensional rendering device, as destination device 40 includes view synthesizing unit 44 and image display 42.

The techniques of this disclosure, which concern calculation of disparity values from depth information, are not necessarily limited to wireless applications or settings. For example, these techniques may apply to over-the-air television broadcasts, cable television transmissions, satellite television transmissions, Internet video transmissions, encoded digital video that is encoded onto a storage medium, or other scenarios. Accordingly, the communication channel may comprise any combination of wireless or wired media suitable for transmission of encoded video and/or picture data.

Image source 22 may comprise an image sensor array, e.g., a digital still picture camera or digital video camera, a computer-readable storage medium comprising one or more stored images, an interface for receiving digital images from an external source, a processing unit that generates digital images such as by executing a video game or other interactive multimedia source, or other sources of image data. Image source 22 may generally correspond to a source of any one or more of captured, pre-captured, and/or computer-generated images. In some examples, image source 22 may correspond to a camera of a cellular telephone. In general, references to images in this disclosure include both still pictures as well as frames of video data. Thus the techniques of this disclosure may apply both to still digital pictures as well as frames of digital video data.

Image source 22 provides first view 50 to depth processing unit 24 for calculation of depth image for objects in the image. Depth processing unit 24 may be configured to automatically calculate depth values for objects in the image. For example, depth processing unit 24 may calculate depth values for objects based on luminance information. In some examples, depth processing unit 24 may be configured to receive depth information from a user. In some examples, image source 22 may capture two views of a scene at different perspectives, and then calculate depth information for objects in the scene based on disparity between the objects in the two views. In various examples, image source 22 may comprise a standard two-dimensional camera, a two camera system that provides a stereoscopic view of a scene, a camera array that captures multiple views of the scene, or a camera that captures one view plus depth information.

Although image source 22 may provide multiple views, depth processing unit 24 may calculate depth information based on the multiple views and source device 20 may transmit only one view plus depth information for each pair of views of a scene. For example, image source 22 may comprise an eight camera array, intended to produce four pairs of views of a scene to be viewed from different angles. Source device 20 may calculate depth information for each pair and transmit only one image of each pair plus the depth information for the pair to destination device 40. Thus, rather than transmitting eight views, source device 20 may transmit four views plus depth information for each of the four views in the form of bitstream 54, in this example. In some examples, depth processing unit 24 may receive depth information for an image from a user.

Depth processing unit 24 passes first view 50 and depth information 52 to encoder 26. Depth information 52 may comprise a depth map image for first view 50. A depth map may comprise a map of depth values for each pixel location associated with an area (e.g., block, slice, or frame) to be displayed. When first view 50 is a digital still picture, encoder 26 may be configured to encode first view 50 as, for example, a Joint Photographic Experts Group (JPEG) image. When first view 50 is a frame of video data, encoder 26 may be configured to encode first view 50 according to a video coding standard such as, for example Motion Picture Experts Group (MPEG), MPEG-2, International Telecommunication Union (ITU) H.263, ITU-T H.264/MPEG-4, H.264 Advanced Video Coding (AVC), ITU-T H.265, or other video encoding standards. Encoder 26 may include depth information 52 along with the encoded image to form bitstream 54, which includes encoded image data along with the depth information. Encoder 26 passes bitstream 54 to transmitter 28.

In some examples, the depth map is estimated. When more than one view is present, stereo matching may be used to estimate depth maps when more than one view is available. However, in 2D to 3D conversion, estimating depth may be more difficult. Nevertheless, depth map estimated by various methods may be used for 3D rendering based on Depth-Image-Based Rendering (DIBR).

The ITU-T H.264/MPEG-4 (AVC) standard, for example, was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Depth processing unit 24 may generate depth information 52 in the form of a depth map. Encoder 26 may be configured to encode the depth map as part of 3D content transmitted as bistream 54. This process can produce one depth map for the one captured view or depth maps for several transmitted views. Encoder 26 may receive one or more views and the depth maps code them with video coding standards like H.264/AVC, MVC, which can jointly code multiple views, or scalable video coding (SVC), which can jointly code depth and texture.

When first view 50 corresponds to a frame of video data, encoder 26 may encode first view 50 in an intra-prediction mode or an inter-prediction mode. As an example, the ITU-T H.264 standard supports intra prediction in various block sizes, such as 16 by 16, 8 by 8, or 4 by 4 for luma components, and 8×8 for chroma components, as well as inter prediction in various block sizes, such as 16×16, 16×8, 8×16, 8×8, 8×4, 4×8 and 4×4 for luma components and corresponding scaled sizes for chroma components. In this disclosure, “N×N” and “N by N” may be used interchangeably to refer to the pixel dimensions of the block in terms of vertical and horizontal dimensions, e.g., 16×16 pixels or 16 by 16 pixels. In general, a 16×16 block will have 16 pixels in a vertical direction and 16 pixels in a horizontal direction. Likewise, an N×N block generally has N pixels in a vertical direction and N pixels in a horizontal direction, where N represents a positive integer value that may be greater than 16. The pixels in a block may be arranged in rows and columns. Blocks may also be N×M, where N and M are integers that are not necessarily equal.

Block sizes that are less than 16 by 16 may be referred to as partitions of a 16 by 16 macroblock. Likewise, for an N×N block, block sizes less than N×N may be referred to as partitions of the N×N block. Video blocks may comprise blocks of pixel data in the pixel domain, or blocks of transform coefficients in the transform domain, e.g., following application of a transform such as a discrete cosine transform (DCT), an integer transform, a wavelet transform, or a conceptually similar transform to the residual video block data representing pixel differences between coded video blocks and predictive video blocks. In some cases, a video block may comprise blocks of quantized transform coefficients in the transform domain.

Smaller video blocks can provide better resolution, and may be used for locations of a video frame that include high levels of detail. In general, macroblocks and the various partitions, sometimes referred to as sub-blocks, may be considered to be video blocks. In addition, a slice may be considered to be a plurality of video blocks, such as macroblocks and/or sub-blocks. Each slice may be an independently decodable unit of a video frame. Alternatively, frames themselves may be decodable units, or other portions of a frame may be defined as decodable units. The term “coded unit” or “coding unit” may refer to any independently decodable unit of a video frame such as an entire frame, a slice of a frame, a group of pictures (GOP) also referred to as a sequence or superframe, or another independently decodable unit defined according to applicable coding techniques.

In general, macroblocks and the various sub-blocks or partitions may all be considered to be video blocks. In addition, a slice may be considered to be a series of video blocks, such as macroblocks and/or sub-blocks or partitions. In general a macroblock may refer to a set of chrominance and luminance values that define a 16 by 16 area of pixels. A luminance block may comprise a 16 by 16 set of values, but may be further partitioned into smaller video blocks, such as 8 by 8 blocks, 4 by 4 blocks, 8 by 4 blocks, 4 by 8 blocks or other sizes. Two different chrominance blocks may define color for the macroblock, and may each comprise 8 by 8 sub-sampled blocks of the color values associated with the 16 by 16 area of pixels. Macroblocks may include syntax information to define the coding modes and/or coding techniques applied to the macroblocks.

Macroblocks or other video blocks may be grouped into decodable units such as slices, frames or other independent units. Each slice may be an independently decodable unit of a video frame. Alternatively, frames themselves may be decodable units, or other portions of a frame may be defined as decodable units. In this disclosure, the term “coded unit” refers to any independently decodable unit of a video frame such as an entire frame, a slice of a frame, a group of pictures (GOPs), or another independently decodable unit defined according to the coding techniques used.

As noted above, image source 22 may provide two views of the same scene to depth processing unit 24 for the purpose of generating depth information. In such examples, encoder 26 may encode only one of the views along with the depth information. In general, the techniques of this disclosure are directed to sending an image along with depth information for the image to a destination device, such as destination device 40, and destination device 40 may be configured to calculate disparity values for objects of the image based on the depth information. Sending only one image along with depth information may reduce bandwidth consumption and/or reduce storage space usage that may otherwise result from sending two encoded views of a scene for producing a three-dimensional image.

Transmitter 28 may send bitstream 54 to receiver 48 of destination device 40. For example, transmitter 28 may encapsulate bitstream 54 using transport level encapsulation techniques, e.g., MPEG-2 Systems techniques. Transmitter 28 may comprise, for example, a network interface, a wireless network interface, a radio frequency transmitter, a transmitter/receiver (transceiver), or other transmission unit. In other examples, source device 20 may be configured to store bitstream 54 to a physical medium such as, for example, an optical storage medium such as a compact disc, a digital video disc, a Blu-Ray disc, flash memory, magnetic media, or other storage media. In such examples, the storage media may be physically transported to the location of destination device 40 and read by an appropriate interface unit for retrieving the data. In some examples, bitstream 54 may be modulated by a modulator/demodulator (MODEM) before being transmitted by transmitter 28.

After receiving bitstream 54 and decapsulating the data, and in some examples, receiver 48 may provide bitstream 54 to decoder 46 (or to a MODEM that demodulates the bitstream, in some examples). Decoder 46 decodes first view 50 as well as depth information 52 from bitstream 54. For example, decoder 46 may recreate first view 50 and a depth map for first view 50 from depth information 52. After decoding of the depth maps, a view synthesis algorithm can be adopted to generate the texture for other views that have not been transmitted. Decoder 46 may also send first view 50 and depth information 52 to view synthesizing unit 44. View synthesizing unit 44 generates a second image based on first view 50 and depth information 52.

In general, the human visual system perceives depth based on an angle of convergence to an object. Objects relatively nearer to the viewer are perceived as closer to the viewer due to the viewer's eyes converging on the object at a greater angle than objects that are relatively further from the viewer. To simulate three dimensions in multimedia such as pictures and video, two images are displayed to a viewer, one image for each of the viewer's eyes. Objects that are located at the same spatial location within the image will be generally perceived as being at the same depth as the screen on which the images are being displayed.

To create the illusion of depth, objects may be shown at slightly different positions in each of the images along the horizontal axis. The difference between the locations of the objects in the two images is referred to as disparity. In general, to make an object appear closer to the viewer, relative to the screen, a negative disparity value may be used, whereas to make an object appear further from the user relative to the screen, a positive disparity value may be used. Pixels with positive or negative disparity may, in some examples, be displayed with more or less resolution to increase or decrease sharpness or blurriness to further create the effect of positive or negative depth from a focal point.

View synthesis can be regarded as a sampling problem which uses densely sampled views to generate a view in an arbitrary view angle. However, in practical applications, the storage or transmission bandwidth required by the densely sampled views may be large. Hence, research has been performed with respect to view synthesis based on sparsely sampled views and their depth maps. Although differentiated in details, those algorithms based on sparsely sampled views are mostly based on 3D warping. In 3D warping, given the depth and the camera model, a pixel of a reference view may be first back-projected from the 2D camera coordinate to a point P in the world coordinates. The point P may then be projected to the destination view (the virtual view to be generated). The two pixels corresponding to different projections of the same object in world coordinates may have the same color intensities.

View synthesizing unit 44 may be configured to calculate disparity values for objects (e.g., pixels, blocks, groups of pixels, or groups of blocks) of an image based on depth values for the objects. View synthesizing unit 44 may use the disparity values to produce a second image 56 from first view 50 that creates a three-dimensional effect when a viewer views first view 50 with one eye and second image 56 with the other eye. View synthesizing unit 44 may pass first view 50 and second image 56 to image display 42 for display to a user.

Image display 42 may comprise a stereoscopic display or an autostereoscopic display. In general, stereoscopic displays simulate three-dimensions by displaying two images while a viewer wears a head mounted unit, such as goggles or glasses, that direct one image into one eye and a second image into the other eye. In some examples, each image is displayed simultaneously, e.g., with the use of polarized glasses or color-filtering glasses. In some examples, the images are alternated rapidly, and the glasses or goggles rapidly alternate shuttering, in synchronization with the display, to cause the correct image to be shown to only the corresponding eye. Autostereoscopic displays do not use glasses but instead may direct the correct images into the viewer's corresponding eyes. For example, autostereoscopic displays may be equipped with cameras to determine where a viewer's eyes are located and mechanical and/or electronic means for directing the images to the viewer's eyes.

As discussed in greater detail below, view synthesizing unit 44 may be configured with depth values for behind the screen, at the screen, and in front of the screen, relative to a viewer. View synthesizing unit 44 may be configured with functions that map the depth of objects represented in image data of bitstream 54 to disparity values. Accordingly, view synthesizing unit 44 may execute one of the functions to calculate disparity values for the objects. After calculating disparity values for objects of first view 50 based on depth information 52, view synthesizing unit 44 may produce second image 56 from first view 50 and the disparity values.

View synthesizing unit 44 may be configured with maximum disparity values for displaying objects at maximum depths in front of or behind the screen. In this manner, view synthesizing unit 44 may be configured with disparity ranges between zero and maximum positive and negative disparity values. The viewer may adjust the configurations to modify the maximum depths in front of or behind the screen objects are displayed by destination device 44. For example, destination device 40 may be in communication with a remote control or other control unit that the viewer may manipulate. The remote control may comprise a user interface that allows the viewer to control the maximum depth in front of the screen and the maximum depth behind the screen at which to display objects. In this manner, the viewer may be capable of adjusting configuration parameters for image display 42 in order to improve the viewing experience.

By being configured with maximum disparity values for objects to be displayed in front of the screen and behind the screen, view synthesizing unit 44 may be able to calculate disparity values based on depth information 52 using relatively simple calculations. For example, view synthesizing unit 44 may be configured with functions that map depth values to disparity values. The functions may comprise linear relationships between the depth and one disparity value within the corresponding disparity range, such that pixels with a depth value in the convergence depth interval are mapped to a disparity value of zero while objects at maximum depth in front of the screen are mapped to a minimum (negative) disparity value, thus shown as in front of the screen, and objects at maximum depth, thus shown as behind the screen, are mapped to maximum (positive) disparity values for behind the screen.

In one example for real-world coordinates, a depth range can be, e.g., [200, 1000] and the convergence depth distance can be, e.g., around 400. Then the maximum depth in front of the screen corresponds to 200 and the maximum depth behind the screen is 1000 and the convergence depth interval can be, e.g., [395, 405]. However, depth values in the real-world coordination might not be available or might be quantized to a smaller dynamic range, which may be, for example, an eight-bit value (ranging from 0 to 255). In some examples, such quantized depth values with a value from 0 to 255 may be used in scenarios when the depth map is to be stored or transmitted or when the depth map is estimated. A typical depth-image based rendering (DIBR) process may include converting low dynamic range quantized depth map to a map in the real-world depth map, before the disparity is calculated. Note that conventionally, a smaller quantized depth value corresponds to a larger depth value in the real-world coordination. In the techniques of this disclosure, however, it is not necessary to do this conversion, thus it is not necessary to know the depth range in the real-world coordination or the conversion function from a quantized depth value to the depth value in the real-world coordination. Considering an example disparity range of [−disₙ, disₚ], when the quantized depth range includes values from dₘᵢₙ (which may be 0) to dₘₐₓ (which may be 255), a depth value dₘᵢₙ is mapped to disₚ and a depth value of dₘₐₓ (which may be 255) is mapped to −disₙ. Note that disₙ is positive in this example. Assume that the convergence depth map interval is [d₀−δ, d₀+δ], then a depth value in this interval is mapped to a disparity of 0. In general, in this disclosure, the phrase “depth value” refers to the value in the lower dynamic range of [dₘᵢₙ, dₘₐₓ]. The δ value may be referred to as a tolerance value, and need not be the same in each direction. That is, d₀ may be modified by a first tolerance value δ₁ and a second, potentially different, tolerance value δ₂, such that [d₀−δ₂, d₀+δ₁] may represent a range of depth values that may all be mapped to a disparity value of zero.

In this manner, destination device 40 may calculate disparity values without using more complicated procedures that take account of additional values such as, for example, focal length, assumed camera parameters, and real-world depth range values. Thus, as opposed to conventional techniques for calculating disparity that rely on focal length values that describe the distance from the camera to the object, depth range that describes actual distance between the camera and various objects, distance between two cameras, viewing distance between a viewer and the screen, and width of the screen, and camera parameters including the intrinsic and extrinsic parameters, the techniques of this disclosure may provide a relatively simple procedure for calculating a disparity value of any pixel, e.g., based on a given disparity range for all the pixels or objects, and the depth (quantized or in the lower dynamic range) of the pixel.

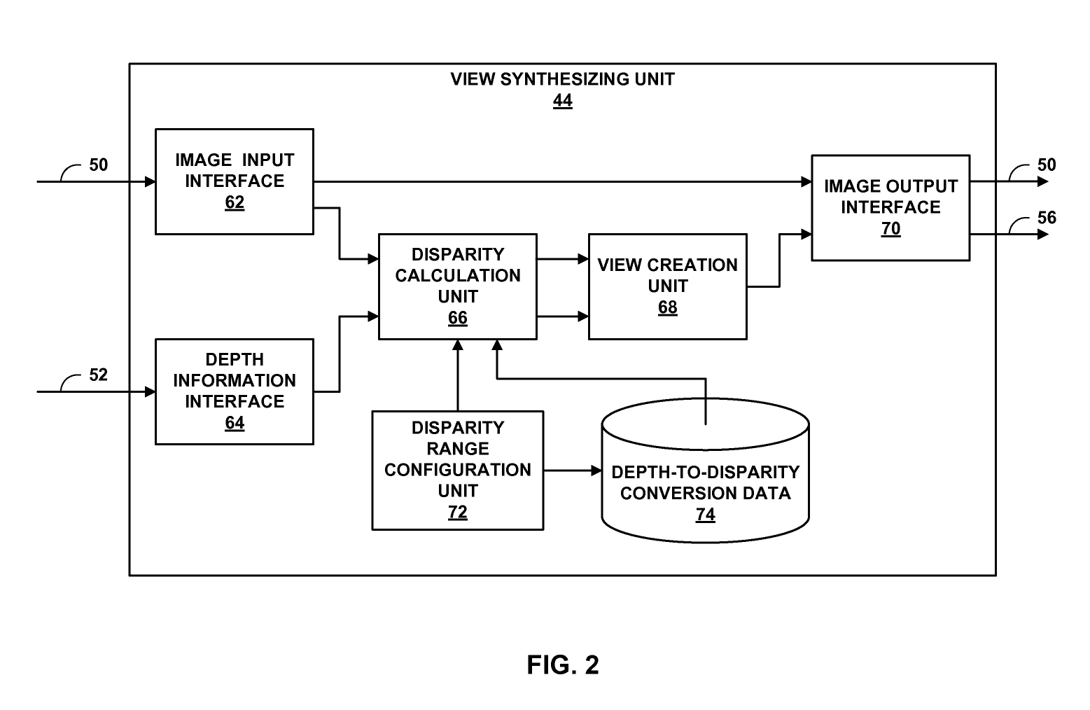

FIG. 2 is a block diagram illustrating an example arrangement of components of view synthesizing unit 44. View synthesizing unit 44 may be implemented in hardware, software, firmware, or any combination thereof. When implemented in software and/or firmware, destination device 40 may include hardware for executing the software, such as, for example, one or more processors or processing units. Any or all of the components of view synthesizing unit 44 may be functionally integrated.

In the example of FIG. 2, view synthesizing unit 44 includes image input interface 62, depth information interface 64, disparity calculation unit 66, disparity range configuration unit 72, depth-to-disparity conversion data 74, view creation unit 68, and image output interface 70. In some examples, image input interface 62 and depth information interface 64 may correspond to the same logical and/or physical interface. In general, image input interface 62 may receive a decoded version of image data from bitstream 54, e.g., first view 50, while depth information interface 64 may receive depth information 52 for first view 50. Image input interface 62 may pass first view 50 to disparity calculation unit 66, and depth information interface 64 may pass depth information 52 to disparity calculation unit 66.

Disparity calculation unit 66 may calculate disparity values for pixels of first view 50 based on depth information 52 for objects and/or pixels of first view 50. Disparity calculation unit 66 may select a function for calculating disparity for a pixel of first view 50 based on depth information for the pixel, e.g., whether the depth information indicates that the pixel is to occur within a short distance of the screen or on the screen, behind the screen, or in front of the screen. Depth-to-disparity conversion data 74 may store instructions for the functions for calculating disparity values for pixels based on depth information for the pixels, as well as maximum disparity values for pixels to be displayed at a maximum depth in front of the screen and behind the screen.

The functions for calculating disparity values may comprise linear relationships between a depth value for a pixel and a corresponding disparity value. For example, the screen may be assigned a depth value d₀. An object having a maximum depth value in front of the screen for bitstream 54 may be assigned a depth value of dₘₐₓ. An object having a maximum depth value behind the screen for bitstream 54 may be assigned a depth value of dₘᵢₙ. That is, dₘₐₓ and dₘᵢₙ may generally describe maximum depth values for depth information 52. In examples where the dynamic range of the stored or transmitted depth map is eight-bit, dₘₐₓ may have a value of 255 and dₘᵢₙ may have a value of 0. When first view 50 corresponds to a picture, dₘₐₓ and dₘᵢₙ may describe maximum values for depths of pixels in the picture, while when first view 50 corresponds to video data, dₘₐₓ and dₘᵢₙ may describe maximum values for depths of pixels in the video and not necessarily within first view 50.

For purposes of explanation, the techniques of this disclosure are described with respect to a screen having a depth value d₀. However, in some examples, d₀ may instead simply correspond to the depth of a convergence plane. For example, when image display 42 corresponds to goggles worn by a user with separate screens for each of the user's eyes, the convergence plane may be assigned a depth value that is relatively far from the screens themselves. In any case, it should be understood that d₀ generally represents the depth of a convergence plane, which may correspond to the depth of a display or may be based on other parameters. In some examples, a user may utilize a remote control device communicatively coupled to image display device 42 to control the convergence depth value d₀. For example, the remote control device may include a user interface including buttons that allow the user to increase or decrease the convergence depth value.

Depth-to-disparity conversion data 74 may store values for dₘₐₓ and dₘₘ, along with maximum disparity values for objects to be displayed at maximum depths in front of and behind the screen. In another example, dₘₐₓ and dₘᵢₙ may be the maximum or minimum values that a given dynamic range can provide. For example, if the dynamic range is 8-bit, then there may be a depth range between 255 (2⁸−1) and 0. So dₘₐₓ and dₘᵢₙ may be fixed for a system. Disparity range configuration unit 72 may receive signals from the remote control device to increase or decrease the maximum disparity value or the minimum disparity value that in turn may increase or decrease the perception of depth of the 3D image rendered. Disparity range configuration unit 72 may, additionally or alternatively to the remote control device, provide a user interface by which a user may adjust disparity range values in front of and behind the screen at which image display 42 displays objects of images. For example, a decreasing the maximum disparity may make the perceived 3D image appear less inside (behind) the screen and decreasing the minimum disparity (which is already negative) may make the perceived 3D image more popped out of the screen.

Depth-to-disparity conversion data 74 may include a depth value δ that controls a relatively small depth interval of values that are mapped to a zero depth and perceived on the screen and otherwise correspond to pixels with a relatively small distance away from the screen. In some examples, disparity calculation unit 66 may assign a disparity of zero to pixels having depth values less than δ in front of or behind the screen, e.g., depth value d₀. That is, in such examples, assuming x is the depth value for the pixel, if (d₀−δ)<=x<=(d₀+δ), disparity calculation unit 66 may assign the pixel a disparity value of zero. In some examples, a user may utilize a remote control device communicatively coupled to image display device 42 to control the δ value. For example, the remote control device may include a user interface including buttons that allow the user to increase (or decrease) the value, such that more (or less) pixels are perceived on the screen.

Depth-to-disparity conversion data 74 may include a first function that disparity calculation unit 66 may execute for calculating disparity values for objects to be displayed behind the screen. The first function may be applied to depth values larger than the convergence depth value of d₀+δ. The first function may map a depth value in the range between convergence depth value and maximum depth value to a disparity value in the range between the minimum disparity value −disₙ and 0. The first function may be a monotone decreasing function of depth. Application of the first function to a depth value may produce a disparity value for creating a 3D perception for a pixel to be displayed in front of the screen, such that and a most popped out pixel has a minimal disparity value of “−disₙ” (where, in this example, disₙ is a positive value). Again assuming that d₀ is the depth of the screen, that δ is a relatively small distance, that x is the value of the pixel, the first function may comprise:

$${f}_{1} ( x ) = - {dis}_{n} * \frac{x - {d}_{0} - δ}{{d}_{max} - {d}_{0} - δ} .$$

In this manner, f₁(x) may map a depth value x of a pixel to a disparity value within a disparity range of −disₙ to 0. In some examples, the disparity value within the disparity range may be proportional to the value of x between d₀+δ and dₘₐₓ, or otherwise be monotonically decreasing.

Depth-to-disparity conversion data 74 may also include a second function that disparity calculation unit 66 may execute for calculating disparity values for objects to be displayed in front of the screen. The second function may be applied to depth values smaller than the convergence depth value of d₀−δ. The second function may map a depth value in the range between minimum depth value and convergence depth value to a disparity value in the range between 0 and the maximum disparity value disₚ. The second function may be a monotone decreasing function of depth. The results of this function with a given depth, is a disparity creating a 3D perception for a pixel to be displayed behind the screen and a deepest pixel has a maximum disparity value of “disₚ.” Again assuming that d₀ is the depth of the screen, that δ is a relatively small distance, that x is the value of the pixel, the second function may comprise:

$${f}_{2} ( x ) = {dis}_{p} * \frac{{d}_{0} - δ - x}{{d}_{0} - δ - {d}_{min}} .$$

In this manner, f₂(x) may map a depth value x of a pixel to a disparity value within a disparity range of 0 to disₚ. In some examples, the disparity value within the disparity range may be proportional to the value of x between d₀−δ and dₘᵢₙ, or otherwise be monotonically decreasing.

Accordingly, disparity calculation unit 66 may calculate disparity for a pixel using the step function (where p represents a pixel and depth(p) represents the depth value associated with pixel p with a depth of x=depth(p)):

$$disparity ( p ) = \{ \begin{matrix}depth ( p ) ε [ {d}_{min} , {d}_{0} - δ ] , & {dis}_{p} * \frac{{d}_{0} - δ - x}{{d}_{0} - δ - {d}_{min}} \\ depth ( p ) ε [ {d}_{0} - δ , {d}_{0} + δ ] , & 0 \\ depth ( p ) ε [ {d}_{0} + δ , {d}_{max} ] , & - {dis}_{n} * \frac{x - {d}_{0} - δ}{{d}_{max} - {d}_{0} - δ}\end{matrix} .$$

The maximum depth in front of or behind the screen at which image display 42 displays objects is not necessarily the same as the maximum depth of depth information 52 from bitstream 54. The maximum depth in front of or behind the screen at which image display 42 displays objects may be configurable based on the maximum disparity values disₙ and disₚ. In some examples, a user may configure the maximum disparity values using a remote control device or other user interface.

It should be understood that depth values dₘᵢₙ and dₘₐₓ are not necessarily the same as the maximum depths in front of and behind the screen resulting from the maximum disparity values. Instead, dₘᵢₙ and dₘₐₓ may be predetermined values, e.g., having a defined range from 0 to 255. Depth processing unit 24 may assign the depth value of a pixel as a global depth value. While the resulting disparity value calculated by view synthesizing unit 44 may be related to the depth value of a particular pixel, the maximum depth in front of or behind the screen at which an object is displayed is based on the maximum disparity values, and not necessarily the maximum depth values dₘᵢₙ and dₘₐₓ.

Disparity range configuration unit 72 may modify values for disₙ and disₚ based on, e.g., signals received from the remote control device or other user interface. Let N be the horizontal resolution (i.e., number of pixels along the x-axis) of a two-dimensional image. Then, for values α and β which may be referred to as disparity adjustment values), disₙ=N*α and disₚ=N*β. In this example, α may be the maximum rate (in contrast to the whole image width) of the negative disparity, which corresponds to a three-dimensional perception of an object outside (or in front of) the screen. In this example, β may be the maximum rate of the positive disparity, which corresponds to a three-dimensional perception of an object behind of (or inside) the screen. In some examples, the following default values may be used as a starting point: for α, (5±2) % and for β, (8±3) %

The maximum disparity values can be device and viewing environment dependent, and can be part of manufacturing parameters. That is, a manufacturer may use the above default values or alter the default parameters at the time of manufacture. Additionally, disparity range configuration unit 72 may provide a mechanism by which a user may adjust the default values, e.g., using a remote control device, a user interface, or other mechanism for adjusting settings of destination device 40.

In response to a signal from a user to increase the depth at which objects are displayed in front of the screen, disparity range configuration unit 72 may increase α. Likewise, in response to a signal from a user to decrease the depth at which objects are displayed in front of the screen, disparity range configuration unit 72 may decrease α. Similarly, in response to a signal from a user to increase the depth at which objects are displayed behind the screen, disparity range configuration unit 72 may increase β, and in response to a signal from a user to decrease the depth at which objects are displayed behind the screen, disparity range configuration unit 72 may decrease β. After increasing or decreasing a and/or β, disparity range configuration unit 72 may recalculate disₙ and/or disₚ and update the values of disₙ and/or disₚ as stored in depth-to-disparity conversion data 74. In this manner, a user may adjust the 3D perception and more specifically the perceived depth at which objects are displayed in front of and/or behind the screen while viewing images, e.g., while viewing a picture or during video playback.

After calculating disparity values for pixels of first image 50, disparity calculation unit 66 may send the disparity values to view creation unit 68. Disparity calculation unit 66 may also forward first image 50 to view creation unit 68, or image input interface 62 may forward first image 50 to view creation unit 68. In some examples, first image 50 may be written to a computer-readable medium such as an image buffer and retrieved by disparity calculation unit 66 and view creation unit 68 from the image buffer.

View creation unit 68 may create second image 56 based on first image 50 and the disparity values for pixels of first image 50. As an example, view creation unit 68 may create a copy of first image 50 as an initial version of second image 56. For each pixel of first image 50 having a non-zero disparity value, view creation unit 68 may change the value of the pixel at a position within second image 56 offset from the pixel of first image 50 by the pixel's disparity value. Thus for a pixel p at position (x, y) having disparity value d, view creation unit 68 may change the value of the pixel at position (x+d, y) to the value of pixel p. View creation unit 68 may further change the value of the pixel at position (x, y) in second image 56, e.g., using conventional hole filling techniques. For example, the new value of the pixel at position (x, y) in second image 56 may be calculated based on neighboring pixels.

View creation unit 68 may then send second view 56 to image output interface 70. Image input interface 62 or view creation unit 68 may send first image 50 to image output interface as well. Image output interface 70 may then output first image 50 and second image 56 to image display 42. Likewise, image display 42 may display first image 50 and second image 56, e.g., simultaneously or in rapid succession.

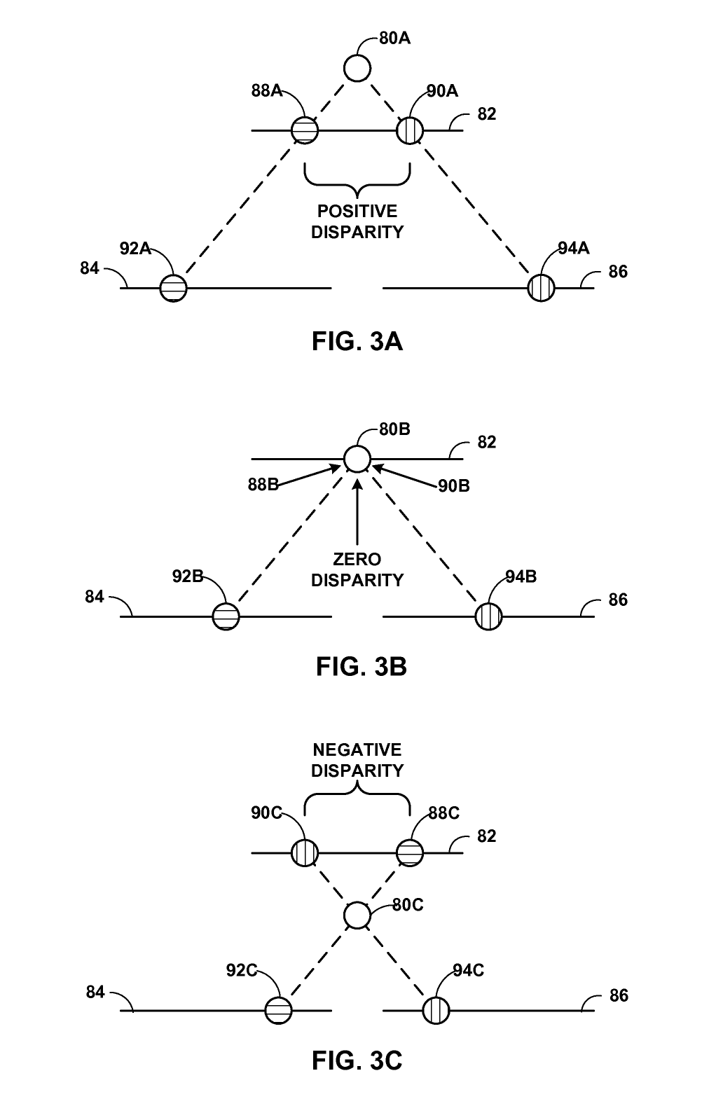

FIGS. 3A-3C are conceptual diagrams illustrating examples of positive, zero, and negative disparity values based on depths of pixels. In general, to create a three-dimensional effect, two images are shown, e.g., on a screen, and pixels of objects that are to be displayed either in front of or behind the screen have positive or negative disparity values respectively, while objects to be displayed at the depth of the screen have disparity values of zero. In some examples, e.g., when a user wears head-mounted goggles, the depth of the “screen” may instead correspond to a common depth d₀.

The examples of FIGS. 3A-3C illustrate examples in which screen 82 displays left image 84 and right image 86, either simultaneously or in rapid succession. FIG. 3A illustrates an example for depicting pixel 80A as occurring behind (or inside) screen 82. In the example of FIG. 3A, screen 82 displays left image pixel 88A and right image pixel 90A, where left image pixel 88A and right image pixel 90A generally correspond to the same object and thus may have similar or identical pixel values. In some examples, luminance and chrominance values for left image pixel 88A and right image pixel 90A may differ slightly to further enhance the three-dimensional viewing experience, e.g., to account for slight variations in illumination or color differences that may occur when viewing an object from slightly different angles.

The position of left image pixel 88A occurs to the left of right image pixel 90A when displayed by screen 82, in this example. That is, there is positive disparity between left image pixel 88A and right image pixel 90A. Assuming the disparity value is d, and that left image pixel 92A occurs at horizontal position x in left image 84, where left image pixel 92A corresponds to left image pixel 88A, right image pixel 94A occurs in right image 86 at horizontal position x+d, where right image pixel 94A corresponds to right image pixel 90A. This may cause a viewer's eyes to converge at a point relatively behind screen 82 when the user's left eye focuses on left image pixel 88A and the user's right eye focuses on right image pixel 90A, creating the illusion that pixel 80A appears behind screen 82.

Left image 84 may correspond to first image 50 as illustrated in FIGS. 1 and 2. In other examples, right image 86 may correspond to first image 50. In order to calculate the positive disparity value in the example of FIG. 3A, view synthesizing unit 44 may receive left image 84 and a depth value for left image pixel 92A that indicates a depth position of left image pixel 92A behind screen 82. View synthesizing unit 44 may copy left image 84 to form right image 86 and change the value of right image pixel 94A to match or resemble the value of left image pixel 92A. That is, right image pixel 94A may have the same or similar luminance and/or chrominance values as left image pixel 92A. Thus screen 82, which may correspond to image display 42, may display left image pixel 88A and right image pixel 90A at substantially the same time, or in rapid succession, to create the effect that pixel 80A occurs behind screen 82.

FIG. 3B illustrates an example for depicting pixel 80B at the depth of screen 82. In the example of FIG. 3B, screen 82 displays left image pixel 88B and right image pixel 90B in the same position. That is, there is zero disparity between left image pixel 88B and right image pixel 90B, in this example. Assuming left image pixel 92B (which corresponds to left image pixel 88B as displayed by screen 82) in left image 84 occurs at horizontal position x, right image pixel 94B (which corresponds to right image pixel 90B as displayed by screen 82) also occurs at horizontal position x in right image 86.

View synthesizing unit 44 may determine that the depth value for left image pixel 92B is at a depth d₀ equivalent to the depth of screen 82 or within a small distance δ from the depth of screen 82. Accordingly, view synthesizing unit 44 may assign left image pixel 92B a disparity value of zero. When constructing right image 86 from left image 84 and the disparity values, view synthesizing unit 44 may leave the value of right image pixel 94B the same as left image pixel 92B.

FIG. 3C illustrates an example for depicting pixel 80C in front of screen 82. In the example of FIG. 3C, screen 82 displays left image pixel 88C to the right of right image pixel 90C. That is, there is a negative disparity between left image pixel 88C and right image pixel 90C, in this example. Accordingly, a user's eyes may converge at a position in front of screen 82, which may create the illusion that pixel 80C appears in front of screen 82.

View synthesizing unit 44 may determine that the depth value for left image pixel 92C is at a depth that is in front of screen 82. Therefore, view synthesizing unit 44 may execute a function that maps the depth of left image pixel 92C to a negative disparity value −d. View synthesizing unit 44 may then construct right image 86 based on left image 84 and the negative disparity value. For example, when constructing right image 86, assuming left image pixel 92C has a horizontal position of x, view synthesizing unit 44 may change the value of the pixel at horizontal position x-d (that is, right image pixel 94C) in right image 86 to the value of left image pixel 92C.

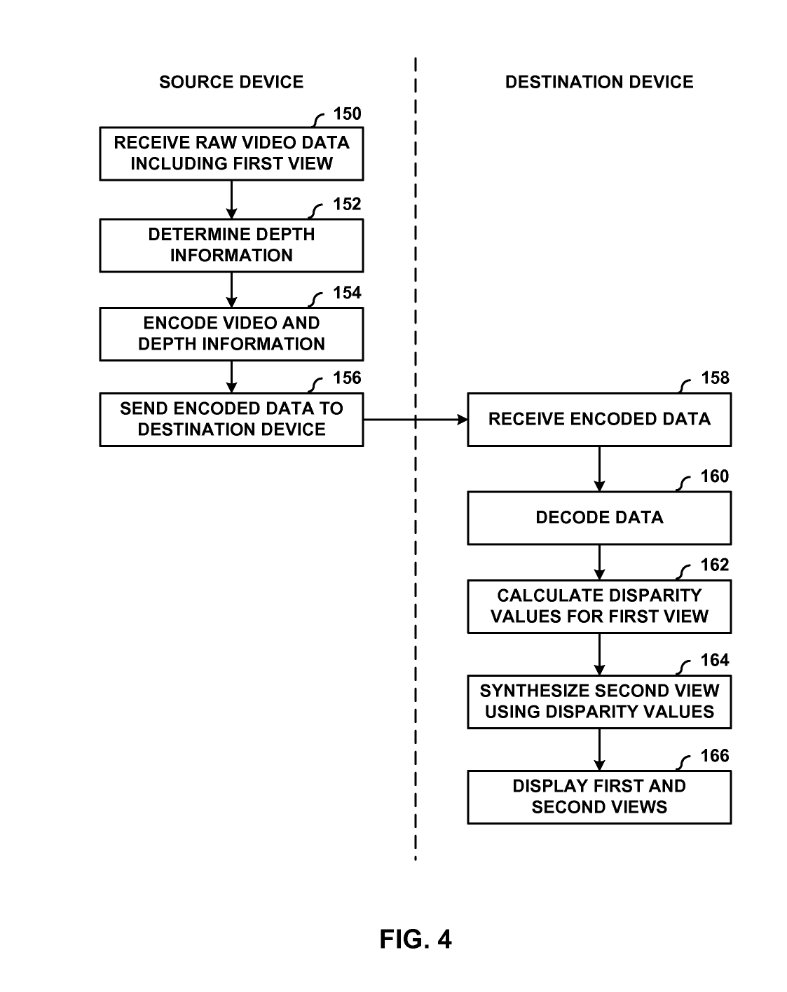

FIG. 4 is a flowchart illustrating an example method for using depth information received from a source device to calculate disparity values and to produce a second view of a scene of an image based on a first view of the scene and the disparity values. Initially, image source 22 receives raw video data including a first view, e.g., first view 50, of a scene (150). As mentioned above, image source 22 may comprise, for example, an image sensor such as a camera, a processing unit that generates image data (e.g., for a video game), or a storage medium that stores the image.

Depth processing unit 24 may then process the first image to determine depth information 52 for pixels of the image (152). The depth information may comprise a depth map, that is, a representation of depth values for each pixel in the image. Depth processing unit 24 may receive the depth information from image source 22 or a user, or calculate the depth information based on, for example, luminance values for pixels of the first image. In some examples, depth processing unit 24 may receive two or more images of the scene and calculate the depth information based on differences between the views.

Encoder 26 may then encode the first image along with the depth information (154). In examples where two images of a scene are captured or produced by image source 22, encoder 26 may still encode only one of the two images after depth processing unit 24 has calculated depth information for the image. Transmitter 28 may then send, e.g., output, the encoded data (156). For example, transmitter 28 may broadcast the encoded data over radio waves, output the encoded data via a network, transmit the encoded data via a satellite or cable transmission, or output the encoded data in other ways. In this manner, source device 20 may produce a bitstream for generating a three-dimensional representation of the scene using only one image and depth information, which may reduce bandwidth consumption when transmitter 28 outputs the encoded image data.

Receiver 48 of destination device 40 may then receive the encoded data (158). Receiver 48 may send the encoded data to decoder 46 to be decoded. Decoder 46 may decode the received data to reproduce the first image as well as the depth information for the first image and send the first image and the depth information to view synthesizing unit 44 (160).

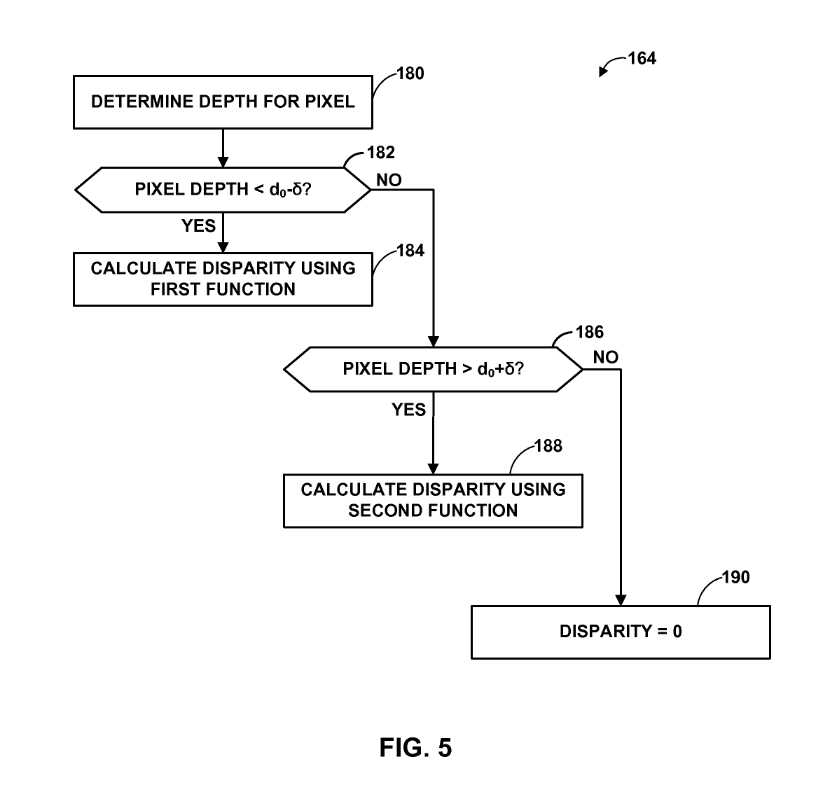

View synthesizing unit 44 may analyze the depth information for the first image to calculate disparity values for pixels of the first image (162). For example, for each pixel, view synthesizing unit 44 may determine whether the depth information for the pixel indicates that the pixel is to be shown behind the screen, at the screen, or in front of the screen and calculate a disparity value for the pixel accordingly. An example method for calculating disparity values for pixels of the first image is described in greater detail below with respect to FIG. 5.

View synthesizing unit 44 may then create a second image based on the first image and the disparity values (164). For example, view synthesizing unit 44 may start with a copy of the first image. Then for each pixel p of the first image at position (x, y) having a non-zero disparity value d, view synthesizing unit 44 may change the value of the pixel in the second image at position (x+d, y) to the value of pixel p. View synthesizing unit 44 may also change the value of the pixel at position (x, y) in the second image using hole-filling techniques, e.g., based on values of surrounding pixels. After synthesizing the second image, image display 42 may display the first and second images, e.g., simultaneously or in rapid succession.

FIG. 5 is a flowchart illustrating an example method for calculating a disparity value for a pixel based on depth information for the pixel. The method of FIG. 5 may correspond to step 164 of FIG. 4. View synthesis module 44 may repeat the method of FIG. 5 for each pixel in an image for which to generate a second image in a stereographic pair, that is, a pair of images used to produce a three-dimensional view of a scene where the two images of the pair are images of the same scene from slightly different angles. Initially, view synthesis module 44 may determine a depth value for the pixel (180), e.g., as provided by a depth map image.

View synthesis module 44 may then determine whether the depth value for the pixel is less than the convergence depth, e.g., d₀, minus a relatively small value δ (182). If so (“YES” branch of 182), view synthesis module 44 may calculate the disparity value for the pixel using a function that maps depth values to a range of potential positive disparity values (184), ranging from zero to a maximum positive disparity value, which may be configurable by a user. For example, where x represents the depth value for the pixel, dₘᵢₙ represents the minimum possible depth value for a pixel, and disₚ represents the maximum positive disparity value, view synthesis module may calculate the disparity for the pixel using the formula

$${f}_{2} ( x ) = {dis}_{p} * \frac{{d}_{0} - δ - x}{{d}_{0} - δ - {d}_{min}} .$$

On the other hand, if the depth value for the pixel is not less than the depth of the screen minus a relatively small value δ (“NO” branch of 182), view synthesis module 44 may determine whether the depth value for the pixel is greater than the convergence depth, e.g., d₀, plus the relatively small value δ (186). If so (“YES” branch of 186), view synthesis module 44 may calculate the disparity value for the pixel using a function that maps depth values to a range of potential negative disparity values (188), ranging from zero to a maximum negative disparity value, which may be configurable by a user. For example, where x represents the depth value for the pixel, dₘₐₓ represents the maximum possible depth value for a pixel, and −disₙ represents the maximum negative (or minimum) disparity value, view synthesis module may calculate the disparity for the pixel using the formula

$${f}_{1} ( x ) = - {dis}_{n} * \frac{x - {d}_{0} - δ}{{d}_{max} - {d}_{0} - δ} ..$$

When the pixel lies between d₀−δ and d₀+δ (“NO” branch of 186), view synthesis module 44 may determine that the disparity value for the pixel is zero (190). In this manner, destination device 40 may calculate disparity values for pixels of an image based on a range of possible positive and negative disparity values and depth values for each of the pixels. Accordingly, destination device 40 need not refer to the focal length, the depth range in the real-world, the distance of assumed cameras or eyes or other camera parameters to calculate disparity values, and ultimately, to produce a second image of a scene from a first image of the scene that may be displayed simultaneously or in rapid succession to present a three-dimensional representation of the scene.

Disparity between pixels of two images may generally be described by the formula:

$$Δ u = h - \frac{f * {t}_{r}}{{z}_{w}}$$

where Δu is the disparity between two pixels, tᵣ is the distance between two cameras capturing two images of the same scene, z_{w} is a depth value for the pixel, h is a shift value related to the difference between the position of the cameras and points on a plane passing through the cameras at which lines of convergence from an object of the scene as captured by the two cameras pass, and f is a focal length describing a distance at which the lines of convergence cross perpendicular lines from the camera to the convergence plane, referred to as the principal axis.

The shift value h is typically used as a control parameter, such that the calculation of disparity can be denoted:

$$Δ u = \frac{f * {t}_{r}}{{z}_{c}} - \frac{f * {t}_{r}}{{z}_{w}}$$

where z_{c} represents a depth at which disparity is zero.

Assume that there is a maximum positive disparity disₚ and a maximum negative disparity disₙ. Let the corresponding real-world depth range be [zₙₑₐᵣ, z_{far}], and the depth of a pixel in the real-world coordinates be z_{w}. Then the disparity of the pixel does not depend upon the focal length and camera (or eye) distance, so the disparity for the pixel can be calculated as follows:

$$Δ u = \{ \begin{matrix}- {dis}_{n} * \frac{{z}_{w} - {z}_{c}}{{z}_{far} - {z}_{c}} if ( {z}_{w} > {z}_{c} ) \\ {dis}_{p} * \frac{{z}_{c} - {z}_{w}}{{z}_{c} - {z}_{near}} if ( {z}_{w} < {z}_{c} )\end{matrix}$$

To demonstrate this, it may be defined that the farthest pixel corresponding to a maximum negative disparity is:

$$- {dis}_{n} = \frac{f * {t}_{r}}{{z}_{c}} - \frac{f * {t}_{r}}{{z}_{far}} .$$

This may be because it is assumed that z_{far} describes a maximum distance in the real world. Similarly, may be defined that the closest pixel corresponding to a maximum positive disparity is:

$${dis}_{p} = \frac{f * {t}_{r}}{{z}_{c}} - \frac{f * {t}_{r}}{{z}_{near}} .$$

Again, this may be because it can be assumed that zₙₑₐᵣ describes a minimum distance in the real world. Thus, if z_{w} is greater than z_{c}, the negative disparity can be calculated as

$$Δ u = - {dis}_{n} * \frac{{z}_{w} - {z}_{c}}{{z}_{far} - {z}_{c}} .$$

On the other hand, if z_{w} is less than z_{c}, the positive disparity can be calculated as:

$$Δ u = {dis}_{p} * \frac{{z}_{c} - {z}_{w}}{{z}_{c} - {z}_{near}} .$$

This disclosure recognizes that the depth map for an image may have errors, and that estimation of the depth range [zₙₑₐᵣ, z_{far}] can be difficult. It may be easier to estimate maximum disparity values disₙ and disₚ, and to assume that the relative positioning of an object in front of or behind z_{c}. A scene can be captured at different resolutions and after three-dimensional warping, the disparity for a pixel may be proportional to the resolution. In other words, the maximum disparity values may be calculated based on the resolution of a display N and rates α and β, such that a maximum positive disparity may be calculated as disₚ=N*β and a maximum negative disparity may be calculated as disₙ=N*α.

A depth estimation algorithm may be more accurate in estimating relative depths between objects than estimating a perfectly accurate depth range for zₙₑₐᵣ and z_{far}. Also, there may be uncertainty during the conversion of some cues, e.g., from motion or blurriness, to real-world depth values. Thus, in practice, the “real” formula for calculating disparity can be simplified to:

$$Δ u = \{ \begin{matrix}- {dis}_{n} * {g}_{1} ( d ) , & if ( d < {d}_{0} ) \\ {dis}_{p} * {g}_{2} ( d ) & if ( d > {d}_{0} )\end{matrix}$$

where d is a depth value that is in a small range relative to [zₙₑₐᵣ, z_{far}], e.g., from 0 to 255.

The techniques of this disclosure recognize that it may be more robust to consider three ranges of potential depth values rather than a single depth value d₀. Assuming that f₁(x) as described above is equal to −disₙ*g₁(x) and that f₂(x) is equal to disₚ*g₂(x), the techniques of this disclosure result. That is, where p represents a pixel and depth(p) represents the depth value associated with pixel p, the disparity of p can be calculated as follows:

$$disparity ( p ) = \{ \begin{matrix}depth ( p ) ∈ [ {d}_{min} , {d}_{0} - δ ] , & {dis}_{p} * \frac{{d}_{0} - δ - x}{{d}_{0} - δ - {d}_{min}} \\ depth ( p ) ∈ [ {d}_{0} - δ , {d}_{0} + δ ] , & 0 \\ depth ( p ) ∈ [ {d}_{0} + δ , {d}_{max} ] , & - {dis}_{n} * \frac{x - {d}_{0} - δ}{{d}_{max} - {d}_{0} - δ} .\end{matrix}$$

In one or more examples, the functions described may be implemented in hardware, software, firmware, or any combination thereof. If implemented in software, the functions may be stored on or transmitted over as one or more instructions or code on a computer-readable medium. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that a computer-readable storage medium and a data storage medium does not include connections, carrier waves, signals, or other transient media, but is instead directed to a non-transient, tangible storage medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method for generating three-dimensional (3D) image data, the method comprising:
calculating, with a 3D rendering device, disparity values for a plurality of pixels of a first image based on depth information associated with the plurality of pixels and a disparity range to which the depth information is mapped, wherein the disparity values describe horizontal offsets for corresponding ones of a plurality of pixels for a second image; and
generating, with the 3D rendering device, the second image based on the first image and the disparity values.

2. The method of claim 1, wherein calculating the disparity values for one of the plurality of pixels comprises:
selecting a function that maps a depth value of the depth information to a disparity value within a defined disparity range; and
executing the selected disparity function based on the depth information for the one of the plurality of pixels.

3. The method of claim 1, wherein calculating the disparity values for the plurality of pixels comprises, for at least one of the plurality of pixels:
determining whether a depth value of the depth information for the one of the plurality of pixels is within a first range comprising depth values larger than a convergence depth value plus a first tolerance value, a second range comprising depth values smaller than the convergence depth value minus a second tolerance value, and a third range comprising depth values between the convergence depth value plus the first tolerance value and the convergence depth value minus the second tolerance value;
executing a first function when the depth information for the one of the plurality of pixels is within the first range;
executing a second function when the depth information for the one of the plurality of pixels is within the second range, and
setting the disparity value for the one of the plurality of pixels equal to zero when the depth information for the one of the plurality of pixels is within the third range.

4. The method of claim 3, wherein the disparity range comprises a minimum, negative disparity value −disₙ, and wherein the first function comprises a monotone decreasing function that maps depth values in the first depth range to a negative disparity value ranging from −disₙ to 0.

5. The method of claim 4, further comprising modifying the minimum, negative disparity value according to a received disparity adjustment value.

6. The method of claim 5, further comprising receiving the disparity adjustment value from a remote control device communicatively coupled to the 3D display device.

7. The method of claim 5, wherein the received disparity adjustment value is expressed as a percentage of a width of the second image.

8. The method of claim 3, wherein the disparity range comprises a maximum, positive disparity value disₚ, and wherein the second function comprises a monotone decreasing function that maps depth values in the second depth range to a positive disparity value ranging from 0 to disₚ.

9. The method of claim 8, further comprising modifying the maximum, positive disparity value according to a received disparity adjustment value.

10. The method of claim 9, further comprising receiving the disparity adjustment value from a remote control device communicatively coupled to the 3D display device.

11. The method of claim 9, wherein the received disparity adjustment value is expressed as a percentage of a width of the second image.

12. The method of claim 3, wherein the first function comprises
$${f}_{1} ( x ) = - {dis}_{n} * \frac{x - {d}_{0} - {δ}_{1}}{{d}_{max} - {d}_{0} - {δ}_{1}} ,$$
wherein the second function comprises
$${f}_{2} ( x ) = {dis}_{p} * \frac{{d}_{0} - {δ}_{2} - x}{{d}_{0} - {δ}_{2} - {d}_{min}} ,$$
wherein dₘᵢₙ comprises a minimum depth value, wherein dₘₐₓ comprises a maximum depth value, wherein d₀ comprises the convergence depth value, wherein δ₁ comprises the first tolerance value, wherein δ₂ comprises the second tolerance value, wherein x comprises the depth value for the one of the plurality of pixels, wherein −disₙ comprises a minimum, negative disparity value for the disparity range, and wherein disₚ comprises a maximum, positive disparity value for the disparity range.

13. The method of claim 1, wherein calculating the disparity values comprises calculating the disparity values without directly using camera models, focal length, real-world depth range values, conversion from low dynamic range depth values to the real-world depth values, real-world convergence distance, viewing distance, and display width.

14. An apparatus for generating three-dimensional image data, the apparatus comprising a view synthesizing unit configured to calculate disparity values for a plurality of pixels of a first image based on depth information associated with the plurality of pixels and disparity ranges to which the depth information is mapped, wherein the disparity values describe horizontal offsets for corresponding ones of a plurality of pixels for a second image, and to generate the second image based on the first image and the disparity values.

15. The apparatus of claim 14, wherein to calculate the disparity value for at least one of the plurality of pixels, the view synthesizing unit is configured to determine whether a depth value of the depth information for the one of the plurality of pixels is within a first range comprising depth values larger than a convergence depth value plus a first tolerance value, a second range comprising depth values smaller than the convergence depth value minus a second tolerance value, and a third range comprising depth values between the convergence depth value plus the first tolerance value and the convergence depth value minus the second tolerance value, execute a first function when the depth information for the one of the plurality of pixels is within the first range, execute a second function when the depth information for the one of the plurality of pixels is within the second range, and set the disparity value for the one of the plurality of pixels equal to zero when the depth information for the one of the plurality of pixels is within the third range.

16. The apparatus of claim 15, wherein the disparity range comprises a minimum, negative disparity value −disₙ, and wherein the first function comprises a monotone decreasing function that maps depth values in the first depth range to a negative disparity value ranging from −disₙ to 0.

17. The apparatus of claim 16, further comprising a disparity range configuration unit configured to modify the minimum, negative disparity value according to a received disparity adjustment value.

18. The apparatus of claim 17, wherein the disparity range configuration unit is configured to receive the disparity adjustment value from a remote control device communicatively coupled to the apparatus.

19. The apparatus of claim 17, wherein the received disparity adjustment value is expressed as a percentage of a width of the second image.

20. The apparatus of claim 15, wherein the disparity range comprises a maximum, positive disparity value disₚ, and wherein the second function comprises a monotone decreasing function that maps depth values in the second depth range to a positive disparity value ranging from 0 to disₚ.

21. The apparatus of claim 20, further comprising a disparity range configuration unit configured to modify the maximum, positive disparity value according to a received disparity adjustment value.

22. The apparatus of claim 21, wherein the disparity range configuration unit is configured to receive the disparity adjustment value from a remote control device communicatively coupled to the apparatus.

23. The apparatus of claim 21, wherein the received disparity adjustment value is expressed as a percentage of a width of the second image.

24. The apparatus of claim 15 wherein the first function comprises
$${f}_{1} ( x ) = - {dis}_{n} * \frac{x - {d}_{0} - {δ}_{1}}{{d}_{max} - {d}_{0} - {δ}_{1}} ,$$
wherein the second function comprises
$${f}_{2} ( x ) = {dis}_{p} * \frac{{d}_{0} - {δ}_{2} - x}{{d}_{0} - {δ}_{2} - {d}_{min}} ,$$
wherein dₘᵢₙ comprises a minimum depth value, wherein dₘₐₓ comprises a maximum depth value, wherein d₀ comprises the convergence depth value, wherein δ₁ comprises the first tolerance value, wherein δ₂ comprises the second tolerance value, wherein x comprises the depth value for the one of the plurality of pixels, wherein −disₙ comprises a minimum, negative disparity value for the disparity range, and wherein disₚ comprises a maximum, positive disparity value for the disparity range.

25. An apparatus for generating three-dimensional (3D) image data, the method comprising:
means for calculating disparity values for a plurality of pixels of a first image based on depth information associated with the plurality of pixels and a disparity range to which the depth information is mapped, wherein the disparity values describe horizontal offsets for corresponding ones of a plurality of pixels for a second image; and
means for generating the second image based on the first image and the disparity values.

26. The apparatus of claim 25, wherein the means for calculating the disparity value for at least one of the plurality of pixels comprises:
means for determining whether a depth value of the depth information for the one of the plurality of pixels is within a first range comprising depth values larger than a convergence depth value plus a first tolerance value, a second range comprising depth values smaller than the convergence depth value minus a second tolerance value, and a third range comprising depth values between the convergence depth value plus the first tolerance value and the convergence depth value minus the second tolerance value;
means for executing a first function when the depth information for the one of the plurality of pixels is within the first range;
means for executing a second function when the depth information for the one of the plurality of pixels is within the second range; and
means for setting the disparity value for the one of the plurality of pixels equal to zero when the depth information for the one of the plurality of pixels is within the third range.

27. The apparatus of claim 26, wherein the disparity range comprises a minimum, negative disparity value −disₙ, and wherein the first function comprises a monotone decreasing function that maps depth values in the first depth range to a negative disparity value ranging from −disₙ to 0.

28. The apparatus of claim 27, further comprising means for modifying the minimum, negative disparity value according to a received disparity adjustment value.

29. The apparatus of claim 28, further comprising means for receiving the disparity adjustment value from a remote control device communicatively coupled to the apparatus.

30. The apparatus of claim 28, wherein the received disparity adjustment value is expressed as a percentage of a width of the second image.

31. The apparatus of claim 26, wherein the disparity range comprises a maximum, positive disparity value disₚ, and wherein the second function comprises a monotone decreasing function that maps depth values in the second depth range to a positive disparity value ranging from 0 to disₚ.

32. The apparatus of claim 31, further comprising means for modifying the maximum, positive disparity value according to a received disparity adjustment value.

33. The apparatus of claim 32, further comprising means for receiving the disparity adjustment value from a remote control device communicatively coupled to the apparatus.

34. The apparatus of claim 32, wherein the received disparity adjustment value is expressed as a percentage of a width of the second image.

35. The apparatus of claim 26, wherein, the first function comprises
$${f}_{1} ( x ) = - {dis}_{n} * \frac{x - {d}_{0} - {δ}_{1}}{{d}_{max} - {d}_{0} - {δ}_{1}} ,$$
wherein the second function comprises
$${f}_{2} ( x ) = {dis}_{p} * \frac{{d}_{0} - {δ}_{2} - x}{{d}_{0} - {δ}_{2} - {d}_{min}} ,$$
wherein dₘᵢₙ comprises a minimum depth value, wherein dₘₐₓ comprises a maximum depth value, wherein d₀ comprises the convergence depth value, wherein δ₁ comprises the first tolerance value, wherein δ₂ comprises the second tolerance value, wherein x comprises the depth value for the one of the plurality of pixels, wherein −disₙ comprises a minimum, negative disparity value for the disparity range, and wherein disₚ comprises a maximum, positive disparity value for the disparity range.

36. A computer-readable storage medium comprising instructions that, when executed, cause a processor of an apparatus for generating three-dimensional (3D) image data to:
calculate disparity values for a plurality of pixels of a first image based on depth information associated with the plurality of pixels and a disparity range to which the depth information is mapped, wherein the disparity values describe horizontal offsets for corresponding ones of a plurality of pixels for a second image; and
generate the second image based on the first image and the disparity values.

37. The computer-readable storage medium of claim 36, wherein the instructions that cause the processor to calculate the disparity values for the plurality of pixels comprise instructions that cause the processor to, for at least one of the plurality of pixels:
determine whether a depth value of the depth information for the one of the plurality of pixels is within a first range comprising depth values larger than a convergence depth value plus a first tolerance value, a second range comprising depth values smaller than the convergence depth value plus a second tolerance value, and a third range comprising depth values between the convergence depth value plus the first tolerance value and the convergence depth value minus the second tolerance value;
execute a first function when the depth information for the one of the plurality of pixels is within the first range;
execute a second function when the depth information for the one of the plurality of pixels is within the second range; and
set the disparity value for the one of the plurality of pixels equal to zero when the depth information for the one of the plurality of pixels is within the third range.

38. The computer-readable storage medium of claim 37, wherein the disparity range comprises a minimum, negative disparity value −disₙ, and wherein the first function comprises a monotone decreasing function that maps depth values in the first depth range to a negative disparity value ranging from −disₙ to 0.

39. The computer-readable storage medium of claim 38, further comprising instructions that cause the processor to modify the minimum, negative disparity value according to a received disparity adjustment value.

40. The computer-readable storage medium of claim 39, further comprising instructions that cause the processor to receive the disparity adjustment value from a remote control device communicatively coupled to the apparatus.

41. The computer-readable storage medium of claim 39, wherein the received disparity adjustment value is expressed as a percentage of a width of the second image.

42. The computer-readable storage medium of claim 37, wherein the disparity range comprises a maximum, positive disparity value disₚ, and wherein the second function comprises a monotone decreasing function that maps depth values in the second depth range to a positive disparity value ranging from 0 to disₚ.

43. The computer-readable storage medium of claim 42, further comprising instructions that cause the processor to modify the maximum, positive disparity value according to a received disparity adjustment value.

44. The computer-readable storage medium of claim 43, further comprising instructions that cause the processor to receive the disparity adjustment value from a remote control device communicatively coupled to the apparatus.

45. The computer-readable storage medium of claim 43, wherein the received disparity adjustment value is expressed as a percentage of a width of the second image.

46. The computer-readable storage medium of claim 37, wherein the first function comprises
$${f}_{1} ( x ) = - {dis}_{n} * \frac{x - {d}_{0} - {δ}_{1}}{{d}_{max} - {d}_{0} - {δ}_{1}} ,$$
wherein the second function comprises
$${f}_{2} ( x ) = {dis}_{p} * \frac{{d}_{0} - {δ}_{2} - x}{{d}_{0} - {δ}_{2} - {d}_{min}} ,$$
wherein dₘᵢₙ comprises a minimum depth value, wherein dₘₐₓ comprises a maximum depth value, wherein d₀ comprises the convergence depth value, wherein δ₁ comprises the first tolerance value, wherein δ₂ comprises the second tolerance value, wherein x comprises the depth value for the one of the plurality of pixels, wherein −disₙ comprises a minimum, negative disparity value for the disparity range, and wherein disₚ comprises a maximum, positive disparity value for the disparity range.
